(19) United States
(12) Patent Application Publication
(10) Pub. No.: US 2004/0249965 A1
(43) Pub. Date: Dec. 9, 2004

(54) Node caching system for streaming media applications

(76) Inventors: Guy Dwayne Huggins, Kennedale, TX (US); Sergey Yasevich, Richardson, TX (US); David Allen Kopaniky, Garland, TX (US)

Correspondence Address: VINSON & ELKINS L.L.P., 1001 FANNIN STREET, 2300 FIRST CITY TOWER, HOUSTON, TX, 77002-6760, US

(21) Appl. No.: 10/429,568

(22) Filed: May 5, 2003

(51) Int. Cl. G06F 15/16

(52) U.S. Cl. 709/231

(57) ABSTRACT

The invention is directed to an edge server and caching system. The edge server may have a cache, cache listing, profile data, multimedia server, and internet information server. A viewer may request a file with a specific version. The edge server may determine if the file is stored locally. If the file is not stored locally, the edge server may simultaneously cache and stream the media. If the file is available, the media may be streamed from the cache. The cache may be managed with a cache listing. The cache listing may be ordered by time of last use and may have profile data. Storage capacity may be managed by deleting the last file in the list. The profile data may be used to manage and distribute streaming media.

### TECHNICAL FIELD OF THE INVENTION

This invention, in general, relates to networks for broadcasting streaming media presentations. More specifically, this invention relates to networks, tools, and methods for caching and referencing a distributed streaming media presentation.

### BACKGROUND OF THE INVENTION

With the growth of the Internet and the increasing costs of travel, streaming media presentations are becoming an important tool for communicating among business associates. Streaming media presentations have also become important for communicating with employees, providing on-demand training, and entertainment. If a streaming media presentation is archived, it also permits those that missed a presentation to review it later.

However, various network limitations prevent extensive use of streaming media systems. Barriers such as network capacity and conflicts with security limit the availability of streaming media presentations to broader audiences. FIG. 1 depicts an exemplary prior art network which may be limited in its use of streaming media presentation software or capabilities. A system 10 depicts a service provider 12 outside a firewall 14. Within the firewall 14 is a typical network structure with a central access point 16 and branch access points 18 and 20. These access points may take the form of routers or switches. Users 21 and 22 are coupled to the branch access point 18 and 20. A user 21 creates a multimedia presentation for broadcast to users 22 connected to both branch access points 18 and 20. The user 21 would transfer the multimedia files to the service provider 12 through the branch access point 18, central access point 16, and firewall 14. The service provider 12 then transfers or broadcasts the presentation back through the firewall 14, the central access point 16, and each of the branch access points 18 and 20.

Such an architecture poses several problems. The firewall 14 may limit access or transfer a file into the system. In addition, some firewall systems 14 restrict the flow of data from certain users or regarding certain port accesses. The firewall 14 typically reads packets before permitting packet transfer, extending the amount of time it takes for a packet to reach a distant end. These limitations may prevent this data transfer altogether or make the presentation appear choppy or disjointed.

Another limitation is in the bandwidth or capacity of the network lines. The service provider 12 may receive one signal and transfer back five signals in this case. As more users 22 are added to the system, the capacities of the various network lines are taxed. For example, the capacity between the firewall and the central access point may have a load of one transfer out and five transfers in. From the central server to the branch office, a typical connection has limited bandwidth. In this case, from a central access point 16 to the branch 20, three signals are required in order to satisfy the request of users 22. For branch access point 18, one output signal 21 and two input signals for users 22 are required, each of these taxing the capacity of the network lines.

It is easily seen that these systems then fail to scale for a company with many branch offices and many more users. Extensive access to streaming media would cripple the network. Further, inefficient caching methods fail to ensure that the most up-to-date file is delivered as requested.

As such, many typical network architectures and streaming media systems are deficient in providing scalable and reliable streaming media capabilities. Many other problems and disadvantages of the prior art will become apparent to one skilled in the art after comparing such prior art with the present invention as described herein.

### SUMMARY OF THE INVENTION

Aspects of the invention are found in a method for caching streaming media for distribution from an edge server. The method includes accessing a media file from a management server, caching the media, and simultaneously distributing the media. The media file may be distributed on request from a viewer. The request may include a version number and file identification.

Aspects of the invention may also be found in a method for ensuring the most recent file is transferred. Webcasts may be organized in profiles. These profiles may be transferred or managed by a management server using an XML document. The method may include testing a profile version number to ascertain the accuracy of the profile. If the profile is not the most recent profile, the edge server may retrieve the latest profile data from the management server. Once the profile is validated, the edge server may test the timestamps of the files in cache against those listed in the profile. If the timestamps are not equivalent, the edge server may acquire the file from the management server. Then, the edge server may serve the file to the viewer.

Further aspects of the invention may be found in a method for managing a media cache. The method may include providing a set of key processors for responding to requests from a management server. The method may also include providing a cache listing ordered by last use and including a profile. Cache size may be managed on command, periodically, or in response to cache size by deleting the last files first.

Additional aspects of the invention are found in an edge server. The edge server may have a processor, memory, network interface, storage, cache, cache list, profiles, multimedia server, and internet information server. These elements may function to perform the methods listed above.

As such, a streaming media caching system is described. Other aspects, advantages and novel features of the present invention will become apparent from the detailed description of the invention when considered in conjunction with the accompanying drawings.

### BRIEF DESCRIPTION OF THE DRAWINGS

For a more complete understanding of the present invention and advantages thereof, reference is now made to the following description taken in conjunction with the accompanying drawings in which like reference numbers indicate like features and wherein:

FIG. 1 is a schematic block diagram depicting an exemplary prior art network;

FIG. 2 is a schematic block diagram depicting an exemplary embodiment of a network, according to the invention;

FIG. 3 is a schematic block diagram depicting an exemplary embodiment of a communication between a creation device and a management server;

FIG. 4 is a schematic block diagram depicting an exemplary embodiment of a network for communication between a management server and a viewer;

FIGS. 5, 6, 7 and 8 are block flow diagrams depicting exemplary methods for use by the system;

FIG. 9 is a schematic diagram depicting an exemplary edge server, according to the invention;

FIG. 10 is a schematic block diagram depicting an exemplary embodiment of communication between a user, management server and edge server;

FIGS. 11-17 are block flow diagrams depicting exemplary methods for use in the invention; and

FIG. 18 is a pictorial depicting an exemplary embodiment of a table, according to the invention.

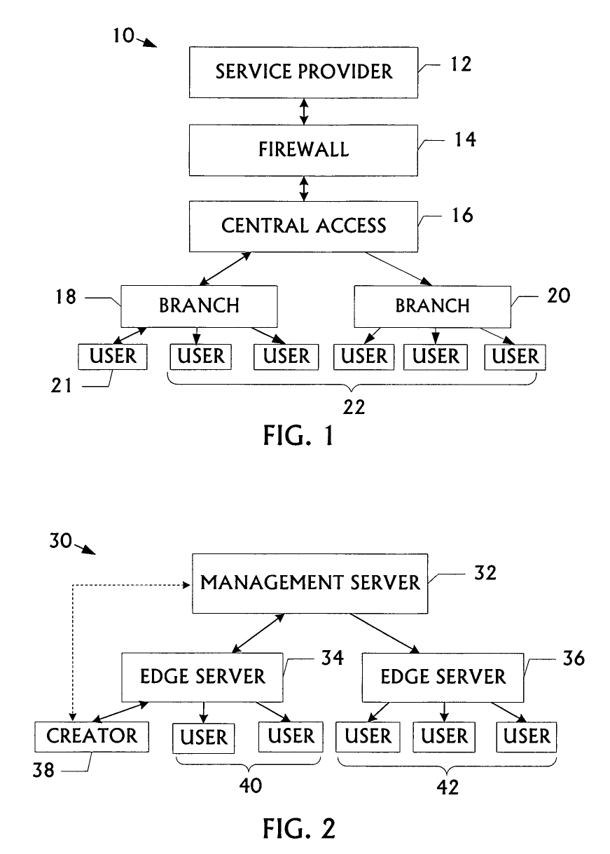

### DETAILED DESCRIPTION OF THE INVENTION

An intranet environment is a managed network with known limitations and structure. A streaming media distribution system designed to adapt to these known limitations and structures is less likely to tax the capacity of the network. In addition, system may be made more secure without the need for firewall interference. Using a management server that distributes media to known network nodes in proximity to users and within the intranet provides for a lower bandwidth solution than external service provider structures. In addition, the creation and distribution may be adapted to the fit known bandwidth and network capacity limits. As such, the system is cost effective and network capacity efficient.

FIG. 2 is a schematic diagram of an exemplary intranet. The intranet 30 has a management server 32 connected to edge servers 34 and 36. A streaming media creation device 38 may communicate with the management server 32 or the edge server 34 to provide a broadcast. If the broadcast is to take place among users 40 associated with the edge server 34, the creation device 38 may establish a publishing point at the edge server 34 and the edge server 34 may distribute streaming media to the users 40. The creation device 38 may then communicate with the management server 32 to upload the archive file. At a later time, the edge server 36 and users 42 may acquire the archived file from the management server 42.

In another exemplary embodiment, the creation device 38 may communicate with the management server 32. Upon request from the users 40 and 42, the management server 32 may retrieve the stream from edge server 34 and stream media to edge server 36. In this scenario, since creator 38 is on the same subnet as edge server 34, the stream is sent from creation device 38 to edge server 34 and served to users 40. Thus the traffic is contained in the local subnet unless a request comes from users 42 on another subnet. Users 42 may request the stream from edge server 36, which in turn requests it from management server 32. The management server 32 in turn requests it from edge server 34. In this manner, the communications channel between the management server 32 and edge servers 34 and 36 or users 40 and 42 are not tasked by requests for multiple instances of streaming media files. However, various transfer scenarios may be envisioned.

A management server 32 and edge servers 34 may take the form of various servers known in the art. The creation device 38 and users 40 and 42 may take various forms including desktop computers, laptop computers, notebook computers, PDAs, ultra portable computers, and smart devices, among others. The network 30 may take various forms and communicate with various standards including Ethernet, wireless Ethernet, TCP/IP, UDP, among others. Network packet may also conform to various standards including HTTP, Microsoft Media Server Protocol (MMSP), Real Time Streaming Protocol (RTSP), SMTP, and FTP, among others.

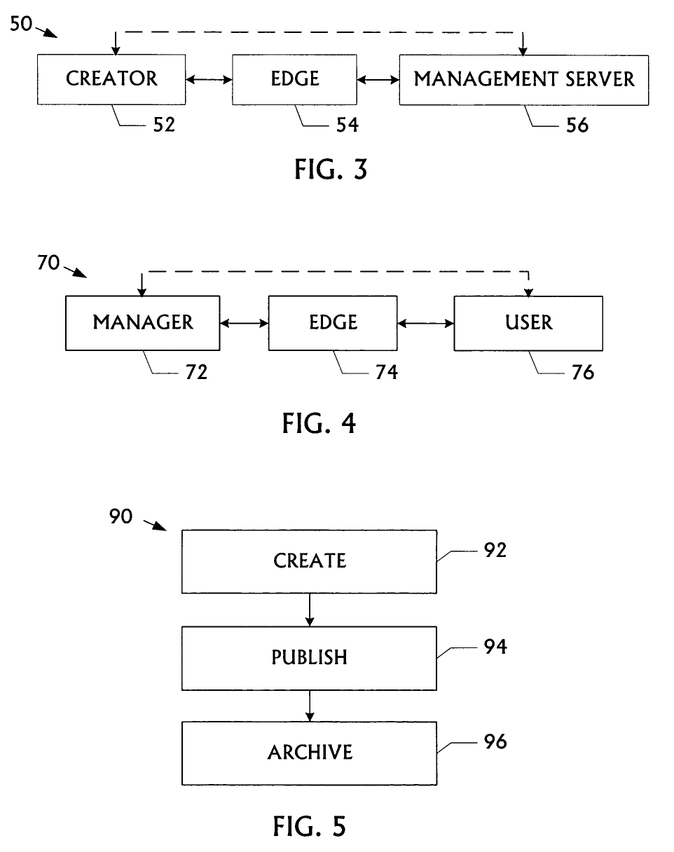

FIG. 3 is a schematic block diagram depicting an exemplary communication between a creation device 52 and a management server 56. The creation device 52 may communicate directly with the management server 56 to upload control data and file date. In the event that the streaming media is to be distributed among many viewers associated with differing edge servers, the creation device 52 may stream media to the edge server 54 and the management server 56 may acquire the stream from the edge server 54. The management server 56 may then distribute the media to other edge servers. However, various structures and transfer paths may be envisioned. Similarly, the creation device 52 may archive streaming media with the management server 56 for later editing and on-demand access, among others.

Alternately, the creation device 52 may communicate with an edge server 54. This case may be useful when each viewer is associated with the edge server 54 associated with the creation device 52. In this manner, the edge server 54 may act as a publishing point. Further, the creation device 52 may subsequently archive the broadcast on management server 56.

FIG. 4 depicts communication from the management server to the user 76. The user 76 may request a broadcast or archived streaming media file. The management server 72 may inform the user 76 of the edge node 74 and a version of the streaming media file. The user 76 may then request the version of the streaming media file from the edge server 74. If the edge server 74 does not have the specific version of the file, the edge server 74 may request the file from the management server 72. The edge server 74 may then simultaneously cache the streaming media file and deliver the streaming media file to the user 76.

FIG. 5 depicts a method 90 for use by the system. A user may create the streaming media presentation as seen in a block 92. The streaming media presentation may take various formats including Windows Media™, Real Networks™ media, Quicktime™ media, and MPEG media, among others. The user may then seek to publish the created streaming media as seen in a block 94. The publication may include communicating with a management server or edge server. Through this communication, the user and servers may establish a set of parameters associated with the bandwidth and quality of the transmission and the permission and availability of the broadcast to members of a network. The permission and availability may further dictate which server, the management server or the edge server, acts as a publishing server. As the files are being broadcast, the creation device may further archive the files for editing and upload them to a management server for subsequent delivery as an on-demand presentation.

For example, a creation tool associated with a creation device may fill an HTML form from the management server with data associated with a broadcast and establish a channel. Alternately, an existing broadcast or parameter set may be selected from an HTML page. The creation tool may then be used to mix a set of media inputs such as slide images, audio files, video files, and input streams such as audio and video feeds. These files may be uploaded and/or streamed to a management server. The management server may store these files, broadcast them, upload them to edge servers, or perform various combinations of the above. However, various examples may be envisaged.

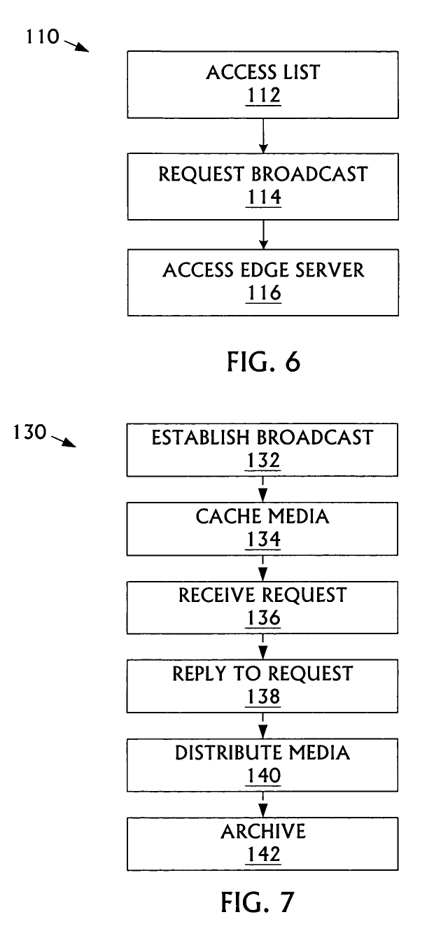

FIG. 6 depicts the actions of a viewer seeking access to the broadcast or on-demand media data. As seen in the method 110, the user may access a list of available streaming media files as seen in block 112. The list presented to the viewer may be a subset of the available archived, on-demand, and broadcast streaming media files available based on the viewer's identification, or network location and capacity, among others. From this list, the viewer may request a broadcast as seen in block 114. This request may take the form of a communication with a management server. The management server may then notify the viewer of a location of an edge server and a version of the media. The viewer may then access the edge server as seen in a block 116. The edge server may have the version requested or may retrieve the version from the management server and broadcast it to the viewer.

In one exemplary embodiment, the viewer has a browser that access HTML or XML pages on the management server. The management server then initiates a media player and directs the player to a edge server. The edge server then streams the media to the viewer from memory or as it is downloaded from the management server.

FIG. 7 depicts a method for use by a management server. The method 130 may start with the establishment of a broadcast as seen in block 132. This establishment of a broadcast may include the exchange of broadcast settings, permissions, and broadcast timing, among others. The server then stores the media for use in the broadcast as seen in a block 134. This media may include images and slides associated with the streaming media. In addition, the media may include various audio and video streams associated with the broadcast. Subsequently, the server may receive a request from a viewer, as seen in a block 136. For example, the viewer may log in, select a broadcast or on-demand streaming media, and establish broadcast parameters such as bandwidth or stream quality. The server may reply to this request as seen in a block 138. The reply may include the location of an edge server and a version of the streaming media. With this information, the viewer may go to the edge server and access the streaming media. The server may then distribute the streaming media to the edge server as seen in block 140. This distribution may include ongoing media streams, on-demand files, or archived files. The distribution may take place at a scheduled time or upon the request of the edge server.

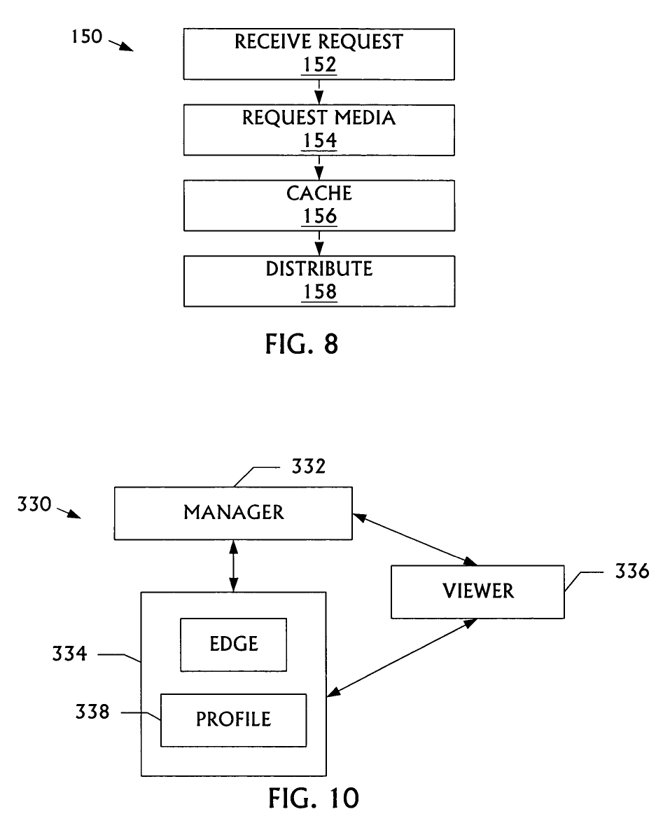

FIG. 8 is a block flow diagram depicting the method of an edge server. The method 150 begins with the edge server receiving the request from a viewer as seen in a block 152. The viewer may request a version of a streaming media file. The edge server may determine whether it has the requested file or media stream and, if it does not, request the media from a management server as seen in a block 154. Subsequently, the server may cache the media stream as seen in a block 156 and distribute that media stream as seen in a block 158. The edge server may simultaneously cache and distribute the file given the appropriate servers and drivers.

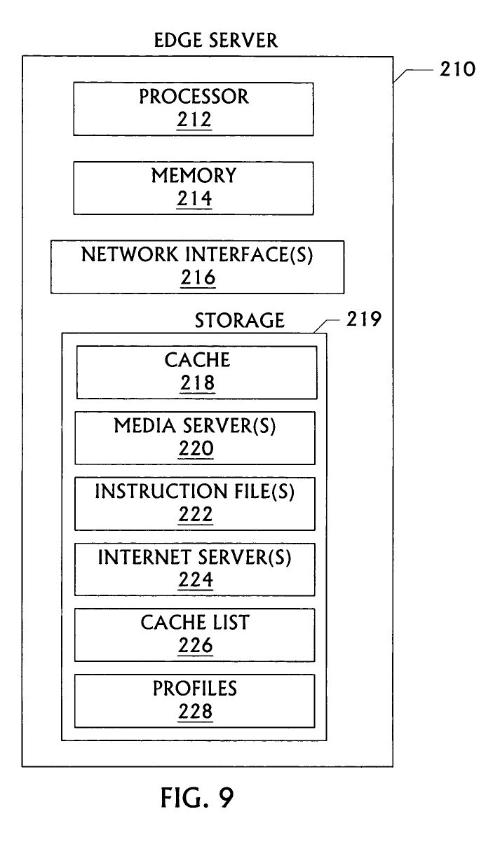

FIG. 9 is a block diagram depicting an exemplary embodiment of an edge server 210. The edge server 210 may have a processor 212, memory 214, network interfaces 216, cache 218, media servers 220, instruction files 222, internet servers 224, cache list 226, and profiles 228, among others. However, these elements may or may not be included together, separately, or in various combinations.

The processor 212 and memory 214 may function together to provide the various functionalities described above and below. The processor 212 may take various forms including a variety of computational circuitries useful in interpreting instructions and performing tasks associated with the server. The memory 214 may take various forms including RAM, ROM, flash memory, floppy disks, hard disks, CDs, DVDs, removable drives, and network storage drives, among others. The storage 219 and the memory 214 may or may not be combined.

The network interfaces 216 may function to communicate with the streaming media creation devices, management servers, and viewers, among others. The network interface may communicate through various hardwire and wired networks and may communicate with various protocols including TCP/IP, UDP, and Ethernet, among others. Further, the network interface 216 may permit the edge server to communicate using protocols such as HTTP, MMSP, RTSP, SMTP, and FTP, among others.

The storage medium 219 may take various forms including those described in relation to the memory 214. Within the storage medium 219 may be a cache 218, multimedia servers 220, instruction files 222, internet servers 224, cache list 226, and profiles 228, among others. The cache 218 may permit the storage of various streaming media files for broadcast or rebroadcast as requested and permitted. The cache 218 may include image files, presentation files, slides, audio files, video files, and various files of streaming media format. The streaming media format files may take the form of Windows Media™, Real Networks™, Quicktime™, MPEG-4, and other standards, among others. The media servers 220 may function to serve the media files upon request from a viewer.

Instructions 222 permit the edge server to determine when to download media files, responding to tasks stored in the edge server task list on the management server, and managing communications with the viewer, among others. The instructions 222 may take various forms including executables, interpretable code, scripts, and drivers, among others. In one exemplary embodiment, the instruction may permit the simultaneous caching and distribution of a media stream. In addition, the instructions 22 may permit the management of the cache list 226.

The edge server 210 may also have an internet server 224. The internet server 224 may permit the distribution of HTML pages, images, and other media.

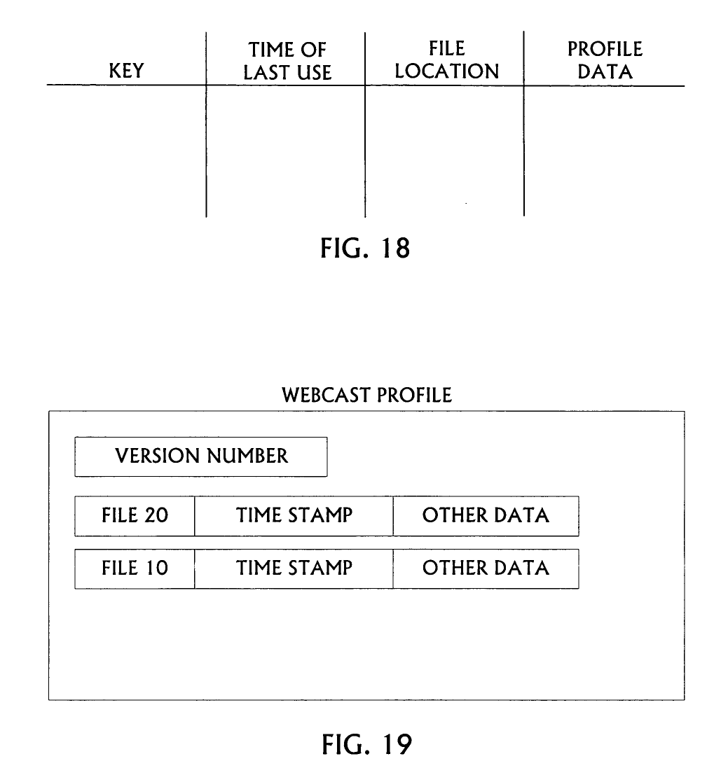

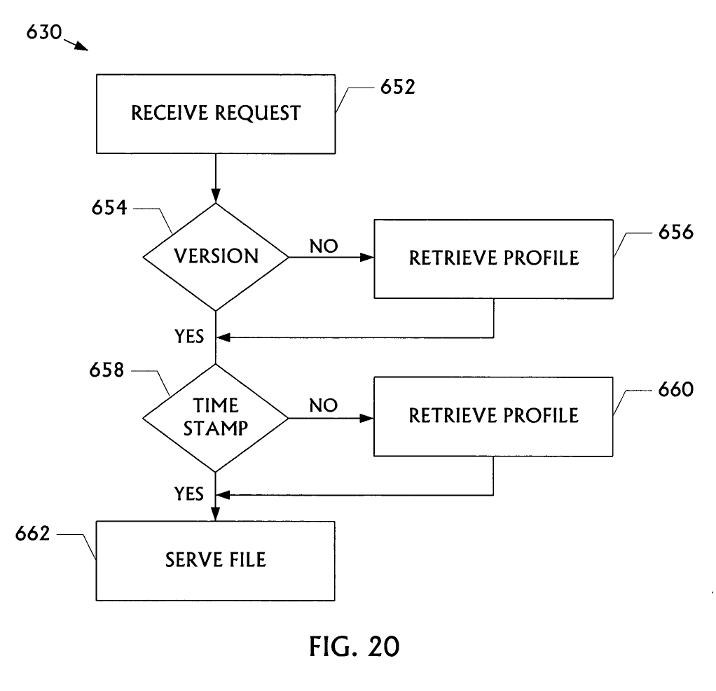

The cache list 226 may be a listing of available cached media files. The listing 226 may include a key, time of last use, file location, and profile data. The listing is discussed in more detail in relation to FIG. 18. The listing 226 may be managed through the management server or with instructions 222. The listing 226 may be used in determining whether a requested version of a file is in cache and managing storage capacity, among other functions.

The edge server 210 may also have a profile data 228. The profile data 228 may include listings of webcasts. The listings may have version numbers and file listings with associated timestamps. One exemplary embodiment of the profile 228 is described in FIG. 19. The profile data may also be used in determining whether a requested version of a file is in cache.

FIG. 10 is a schematic block diagram depicting the communication between the viewer 336, the management server 332 and edge server 334. The viewer 336 may request a list of available broadcasts from the management server 332. This request may include the user identification and network location of the user 336. The management server 332 may respond to the user 336 with a listing of available broadcasts or on-demand presentations. The user 336 may then select one of these broadcasts from the management server 332. This information transfer may take various forms including HTTP communication and HTML or XML Web pages, among others.

Once a broadcast is selected by the user 336, the management server 332 will send to the user 336 a location and version of the desired streaming media or webcast. The location is typically the edge server 334. The user 336 then requests the streaming media from the edge server 334, including in the request the version of the streaming media. For example, the streaming media and other files may be associated in a webcast data entry having a version number. The edge server 334 may test to determine whether it has the appropriate version of the file. For example, the edge server 334 may search a listing of profiles 338 for the version of the webcast and/or timestamp of the requested file. If it does not, the edge server 334 may retrieve the file from the management server 332. The edge server 334 may simultaneously cache the file it is retrieving from the management server 332 and distribute the media.

For on-demand presentations, the management server 332 may, through the job list, direct the edge server 334 to download frequently used files during off-peak times-or at set times. The edge server may update the listing of file profiles 338 as files are cached or deleted.

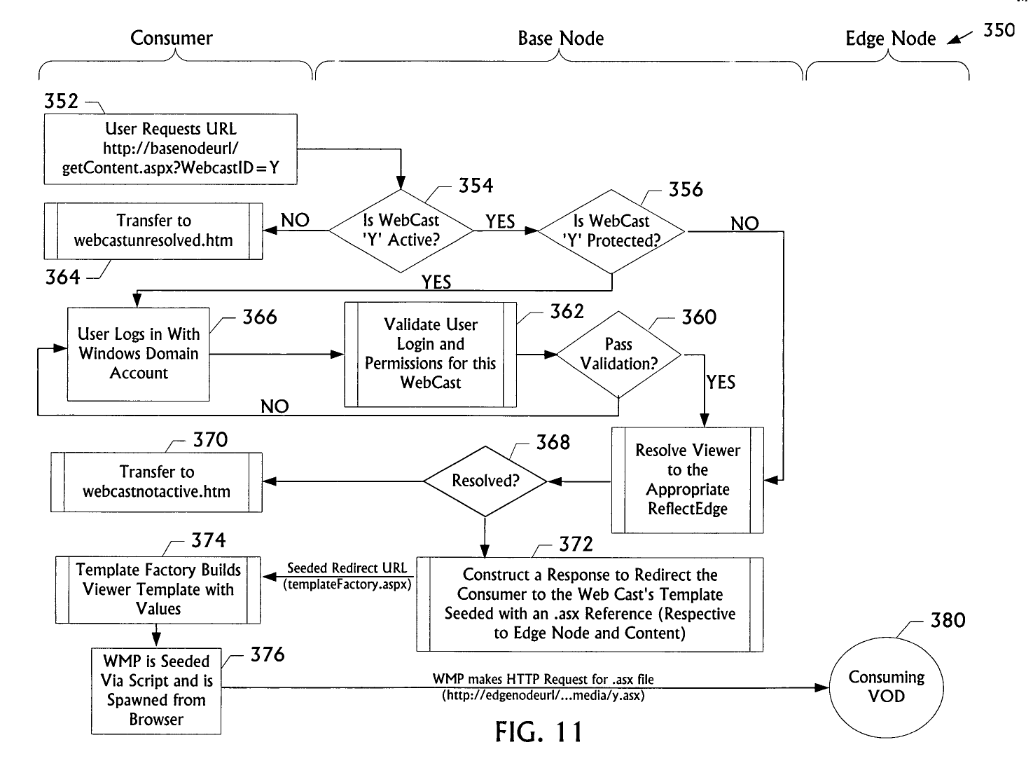

If multiple users are accessing the same files from the edge server 334, the amount of network traffic between the management server 332 and remote office or edge server 334 is limited. An efficient method of accessing files is presented in FIG. 11. FIG. 11 depicts a method 350 for requesting media. A user requests the media as seen in block 352 from a management node. The management node determines whether the webcast is active, as seen in a block 354. If the webcast is not active, the management node transmits back to the consumer/viewer a “webcast not active page” as seen in block 364. However, if the webcast is active, the management node determines whether the webcast is protected as seen in block 356. If the webcast is protected, the management node requires a user log in as seen in block 366.

As seen in blocks 362 and 360, the management node determines whether the user has permission to view the webcast. If not, the user may be prompted to reenter login information as seen in block 366. However, if the user does pass validation, or the webcast is not protected, the management node determines which edge node is to be responsible for the broadcast as seen in block 358. If the management node is not able to determine an edge node as seen in block 368, a webcast unresolved page is sent to the consumer as seen in block 370. However, if the edge server is resolved, the management node constructs a response to redirect the consumer to content on the edge node as seen in block 372. The consumer then builds a template as seen in block 374 and spawns a window as seen in block 376. The window then requests the webcast from the edge node as seen in block 380.

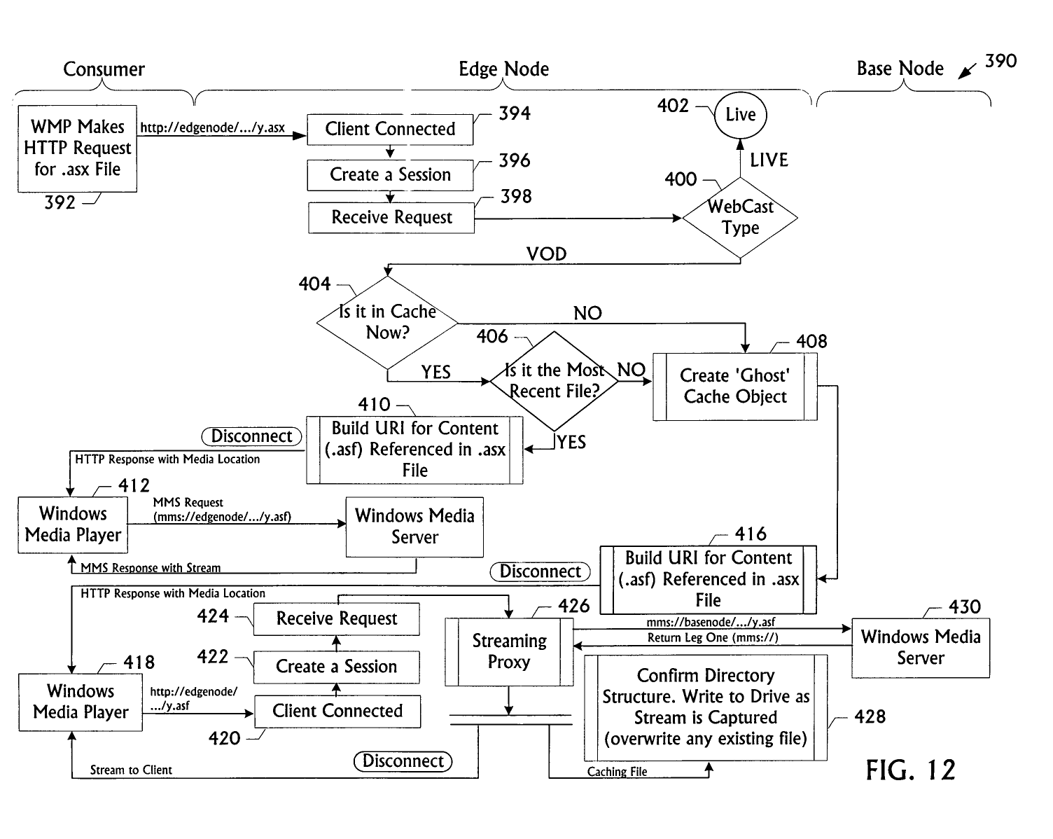

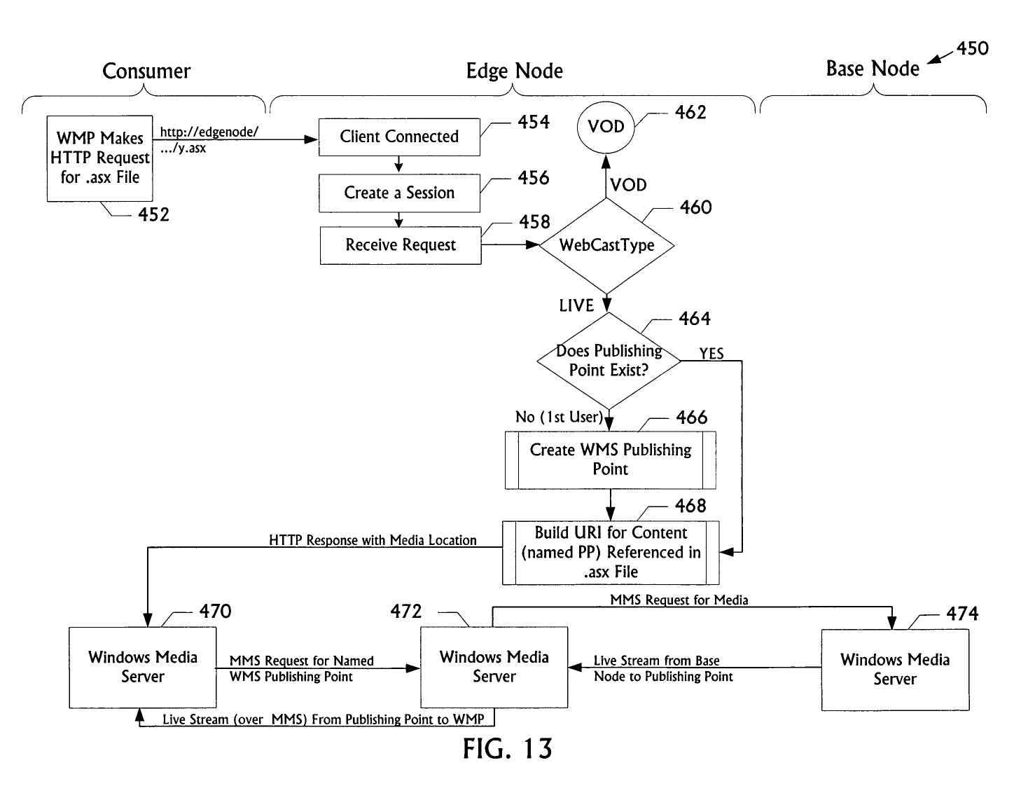

FIG. 12 depicts an exemplary method 390 for consuming on-demand streaming media presentations from an edge node. A spawned window requests a file from an edge node as seen in block 392. The edge node determines whether the client is connected, creates a session and receives the request as seen in block 394, 396 and 398. The edge node then determines what type of webcast has been requested as seen in block 400. If the request is for a live webcast, the client is directed to the method as seen in FIG. 13. However, if the webcast type is for an on-demand presentation, the edge node determines whether the presentation or media are in cache as seen in block 404. This may be accomplished through the use of cache listing. If the media is in cache, the edge node may determine whether this is the most recent file as seen in a block 406. This may be performed by checking version numbers included with the request from the consumer. For example, the version number may be compared with profile information in the webcast profile listing. If the most recent file is available and in cache, the edge node may build a file as seen in block 410. The media player may be launched on the consumer as seen in block 412 and request the media from the edge node as seen in block 414. For example, the player may be launched as part of a template page provided by the edge server. The edge node then serves the media back to the windows player 412.

If the media is not in cache, the edge node may create a ghost cache object as seen in a block 408. The system may then build a file as seen in block 416 that results in the launching of the Windows™ Media™ player by the consumer as seen in block 418. However, in this case, the Windows Media™ player responds back to the edge node. The edge node. connects the client, creates a session and receives a request as seen in blocks 420, 422 and 424, respectively. Then, the edge node creates a streaming proxy 426. This streaming proxy requests the streaming media from the management node media server 430. The media is returned to the streaming proxy which writes the file to cache while simultaneously streaming the file to the Windows Media™ player 418.

FIG. 13 depicts a consumer requesting a live event. If the media to be consumed is associated with a live event, the consumer may again request the media as seen in a block 452. Here too, the edge node connects the client, creates a session and receives the request as seen in blocks 454, 456 and 458, respectively. The webcast type is tested as seen in block 460. If the webcast type is a video on demand or on demand media, the method of FIG. 12 is used as seen in block 462.

However, if the webcast type is live, the edge node determines if a publishing point exists. If a publishing point does not exist, the edge node may create a Windows Media™ server publishing point as seen in block 466. This may be the case if this is the first user requesting the live file. If the publishing point exists or one is created, a file is built as seen in block 468, resulting in the launching of the Windows Media™ player as seen in block 470. The Windows Media™ player requests the media from the Windows Media™ server 472, which in turn requests the media from the Windows Media™ server 474 located at the management node. Subsequently, the media is transferred from the Windows Media™ server 474 to the Windows Media™ server 472 and out to the Windows Media™ player 470. Streaming media may contain references to slides and images.

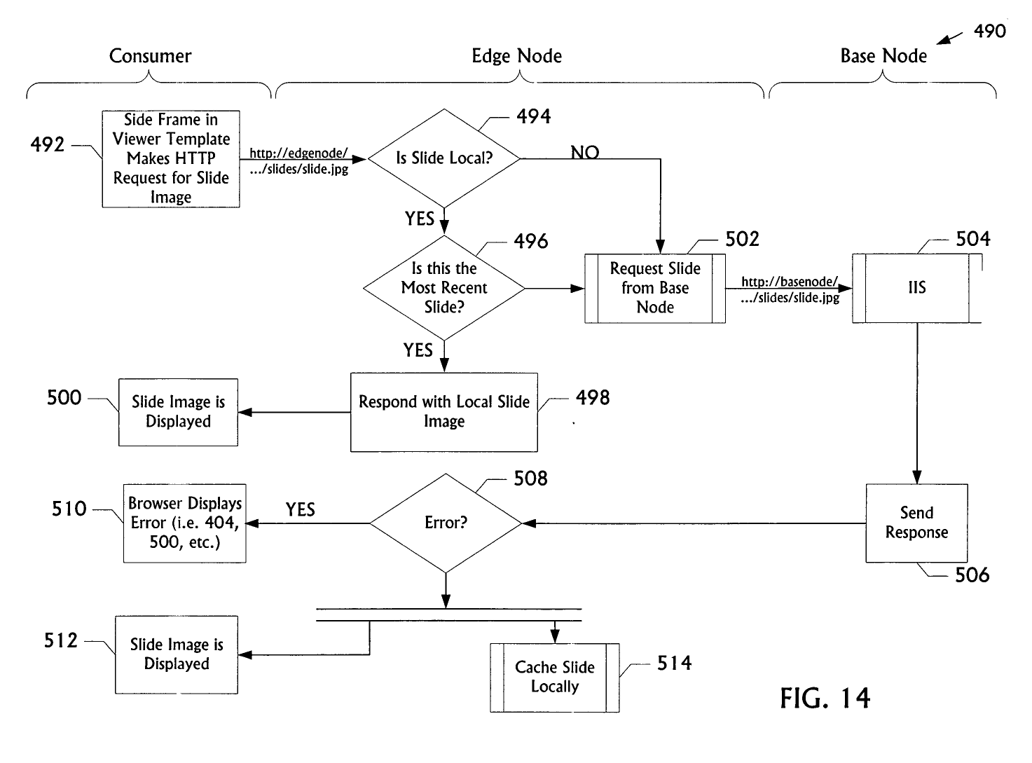

The method 490 of FIG. 14 depicts the consumption of slides. A consumer template makes a request for a slide as seen in a block 492. The edge node determines if the slide available locally, as seen in a block 494. If the slide is available locally, the system determines whether this is the most recent slide as seen in a block 496. This may be performed by using version numbers requested through the consumer and file timestamps. If the slide is the most recent one, the server may respond with the local slide image as seen in a block 498 and the slide may be displayed by the consumer as seen in a block 500.

If the slide is not the most recent slide or the slide is not available locally, a request for the slide may be made from the management node. The Internet information server 504 on the management node may send a response as seen in a block 506 to the edge node. The edge node may then determine whether an error has been made as seen in a block 508. If an error is detected, a browser error message may be displayed on the consumer device as seen in 510. However, if an error is not detected, the slide may be simultaneously cached locally as seen in a block 514 and displayed by the consumer as seen in a block 512.

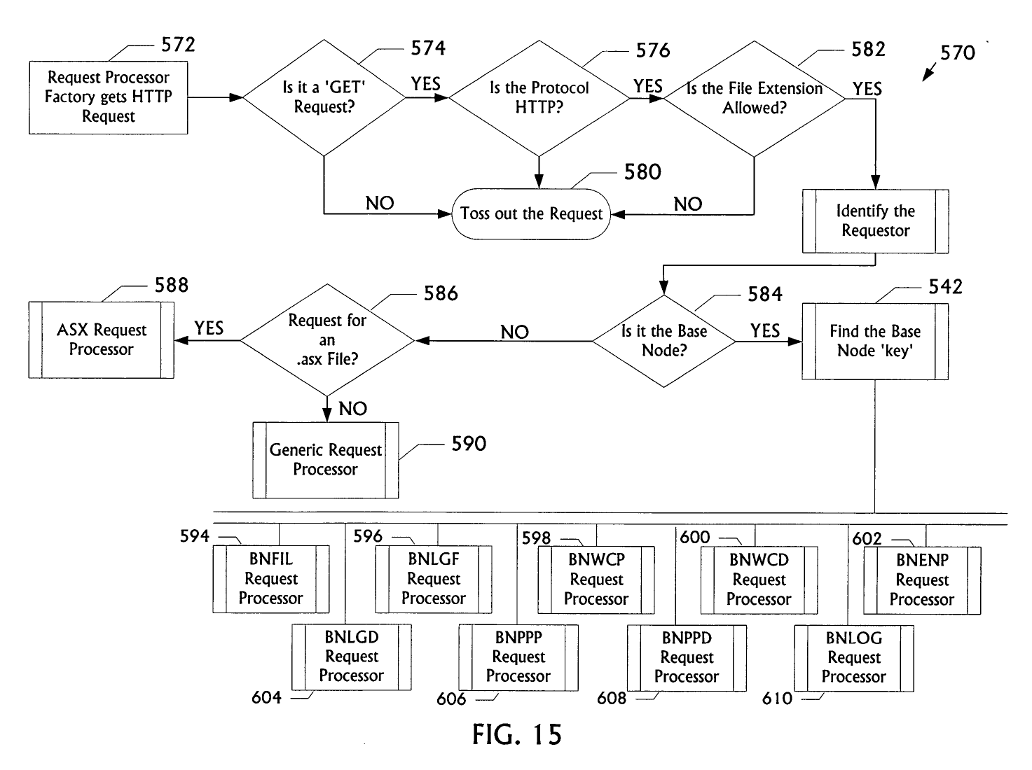

FIG. 15 depicts an exemplary method 570 for processing requests on an edge server. The method 570 begins with the receipt of a request as seen in block 572. The edge server determines whether the request is an HTTP GET request for a file with a permissible file extension as seen in blocks 574, 576, and 578. If the request is not, the request is ignored to tossed as seen in block 580.

If the request is an HTTP GET request for a file with a permissible file extension, the server may identify the requester as seen in block 582. This identification may be the recognition of a network address or testing the login of the user, among others.

The edge server then determines whether the request is from a management node. If the request is not from a management node, the server tests to determine whether the file is a .ASX file. If it is, the server uses and ASX request processor as seen in block 588. If is not a .ASX file request, the server uses a generic request processor as seen in block 590.

However, if the request is from a management node, the server seeks a management node key as seen in block 592. The key may determine which processor to use. For example, the key may indicate the use of the BNFIL request processor 594. The BNFIL request processor 594 directs the edge node or server to make it's own HTTP request to the management node for a content artifact. The BNLGF request processor 596 processes request for a specific Windows Media Server™ log located on the edge node. The BNWCP request processor 598 directs the edge node to make it's own HTTP request to the management node for an updated webcast profile. The BNWCD request processor 600 processes requests for the edge server to delete a webcast. The BNENP request processor 602 processes command for the edge node to make an HTTP request to the management node for an updated edge node profile. The BNLGD request processor 604 directs the edge node to delete its Windows Media Server™ log. The BNPPP request processor 606 directs the edge node to create a Windows Media Server™ publish point. The BNPPD request processor 608 directs the edge node to delete a Windows Media Server™ publishing point. The BNLOG request processor 610 processes request for a listing of Windows Media Server™ logs located on the edge node. Other processors may be used to direct the deleting of files and other functions. The HTTP GET method may be used in conjunction with a job or task list periodically accessed on the management server or node.

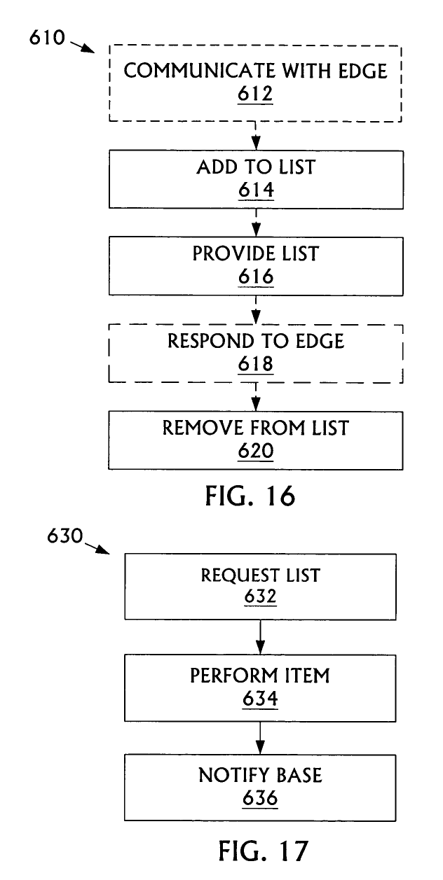

FIG. 16 is a block flow diagram depicting an exemplary method for managing edge servers. The method 610 may begin with communication from the management server to the edge server as seen in block 612. This communication may be a command, a notification that a task is to be added to a task list, or other communication. For example, a command may be issued through the method of FIG. 15. However, there may or may not be communication with the edge server directly. The task is then added to a task or job list as seen in a block 614. The task or job list may reside on the management node. The management node may then provide the list as seen in a block 616 as requested by the edge server. The task or job list may include requests for configuration changes, cache management commands, instructions for downloading streaming media files, and instructions for providing log files, among others. The job may require that the edge server retrieve the data from the management server. As such, the management server may respond to requests of the edge server as seen in a block 618 with the data requested. Once the task is completed, the edge server may notify the management server that the task is completed and removed from the task or job list as seen in a block 620.

The edge server as seen in FIG. 17 may request the list or items on the list from the management server as seen in a block 632. This request may be made at established times or periodically. Once an item is retrieved, the edge server may perform that item as seen in block 634. For example, the edge server may download a new version of a video-on-demand file. Alternately, the edge server may perform a reconfiguration as directed. However, various tasks may be envisaged. Once the edge server has performed the task, the edge server may notify the management server as seen in a block 636. In this manner, the management server may acknowledge the performance of that task and remove the task from the list.

FIG. 18 is a pictorial depicting an exemplary embodiment of a cache list as seen in FIG. 9. Each listing in the cache list may have a key, time of last use, file location, and profile data. The key may be an alpha-numeric reference number. The time of last use may be a date/time entry. The file location may be a name for comparison with a directory or a directory listing. The profile data may include a webcast identifier, version number, size, bit rate, quality, file name, or other data associated with files, among others. However, the profile data may include one or more of these data, among others.

The list may be ordered by most recent use. As files go unused, they fall to the bottom of the list. Memory may then be managed by deleting files from the bottom of the list.

Files may be managed by command from a management server or manager. Also, files may be managed through a task list on the management server. In addition, files may be managed through automated rules on the edge server.

When a viewer requests a file, the edge server may access the list, search for the file, and compare the file profile to the version number requested.

FIG. 19 is a pictorial of a webcast profile. The webcast profile is a collection of data about files associated with a webcast. For example, a webcast profile may be created for each on-demand presentation, among others. The webcast profile may have an associated version number, among other data. In addition, the webcast profile may have a listing of associated files with timestamps and other file data.

The webcast profile may be stored in a set of database tables, an XML document, a text document, a spreadsheet, or other data formats. In one exemplary embodiment, the management server sends an XML document of webcast profiles to the edge server whenever one profile changes. In an alternate example, the management server may place an update task in the edge server task list. The edge server may compare the profile version number and file timestamps included in a request for a file to determine if it has the most current file.

FIG. 20 is an exemplary method for using a webcast profile. Such a method 650 may be used in conjunction with the communication paths of FIG. 10 and the method of FIG. 12. The edge server may receive a request for a file from a user or viewer as seen in block 652. The request may include a version number of a webcast and the identification of a file sought.

As seen in block 654, the edge server may test the version number to determine if the version of the profile data is the most current version. If it is not, the edge server may acquire the profile data from the management server as seen in block 656. Once the edge server has the correct profile version, the edge server may compare the timestamps to determine whether it has the most recent version of the requested file as seen in block 658. If it does not, the edge server may acquire the requested file from the management server as seen in block 660.

Then, the edge server may serve the requested file to the user or viewer as seen in block 662. Similar to FIG. 12, the edge server may also cache the file while streaming.

As such, a streaming media caching system is described in relation to an efficient, secure, streaming media system. In view of the above detailed description of the present invention and associated drawings, other modifications and variations will now become apparent to those skilled in the art. It should also be apparent that such other modifications and variations may be effected without departing from the spirit and scope of the present invention.

What is claimed:

1. An edge server and caching system, comprising:
a cache;
a cache listing;
profile data;
a multimedia server; and
an internet information server, wherein a viewer requests a file having a specific version, wherein the edge server determines if said requested file is stored locally, and wherein if said requested file is not stored locally, the edge server may simultaneously cache and stream said requested file from said multimedia server, and wherein if said requested file is located locally, said file is streamed from cache.

2. The edge server and caching system of claim 1, wherein The cache may be managed with a cache listing. The cache listing may be ordered by time of last use and may have profile data. Storage capacity may be managed by deleting the last file in the list. The profile data may be used to manage and distribute streaming media.

3. A method for caching streaming media for distribution from an edge server, comprising the steps of:
accessing a media file from a management server;
caching said media file and simultaneously distributing the media, wherein said media file is distributed on request from a viewer.

4. The method of claim 3, wherein said request includes a version number and file identification.

5. The method of claim 3, further comprising steps for ensuring a most recent version of a media file is transferred.

6. The method of claim 5, wherein said media file comprises Webcasts organized according to profiles.

7. The method of claim 6, wherein profiles may be transferred or managed by a management server using an XML document.

8. The method of claim 7, further comprising the step of testing a profile version number to ascertain the accuracy of the profile, wherein if said profile is not a most recent profile, then said edge server may retrieve a latest profile data from said management server.

9. The method of claim 8, further comprising the steps of:
validating said profile, after which said edge server tests a timestamp of said media files in cache against said profile, and wherein if said timestamps are not equivalent, the edge server acquires said media file from said management server; and
serving said media file to said viewer.
